(19) United States
(12) Patent Application Publication
(10) Pub. No.: US 2008/0108961 A1
(43) Pub. Date: May 8, 2008

(54) DISPOSABLE COMMODE LINER

(75) Inventor: Paul S. Kik, Hudsonville, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: The Noble Company

(21) Appl. No.: 11/555,926

(22) Filed: Nov. 2, 2006

(51) Int. Cl. A61J 1/00

(52) U.S. Cl. 604/323

(57) ABSTRACT

A collection bag includes opposing panels heat-sealed together to form upper and lower chambers separated by apertures to allow for gravitational separation of collected urinal and fecal matter. Markings facilitate measurement of the collected matter. A clamp allows one-hand release of an opening in lower chamber, and then the clamp can be re-clamped with a single hand for waste containment and bag disposal. A drawstring facilitates attachment of the bag in the commode, and further allows the bag once removed to be closed at its top. For disposal, the bag can be folded using the clamp as a grip, with the excess length of the drawstring used to tie the bag closed. If desired, a rubber band can be used to hold the drawstring and bag in a permanent folded condition. A related method is also disclosed.

### BACKGROUND

The present invention relates to commode liners adapted to assist with measuring patient output, and for safety and convenience of nursing and health care professional staff.

In hospital, nursing care facilities, rehabilitation facilities, and other medical care situations, it is often necessary to measure waste output (urine and fecal matter) as part of monitoring a patient's progress. However, many present commode liners are not satisfactory since health care workers must guess on the amount and content of waste output. Further, many commode liners are difficult to use, resulting in potentially messy and unsanitary situations. Since health care workers are sensitive to and aware of health risks, this can result in improper disposal, because the health care workers may not follow procedures (such as folding and sealingly closing a used commode liner) in an effort to avoid “extra” handling of a used and messy commode liner. Also, many patients do not feel well and/or are lower functioning, such that they are not able to help when using the commode liner. This adds to the health care worker's dilemma, since they are trying to deal with the patient as well as take proper care of the used commode liner. On top of all this is the competitiveness in this industry and the rising health care costs, such that any solution must preferably be low-cost yet highly effective. As a result, there are serious concerns that commode liners must better address, such as infection control, satisfaction of the patient and also of the health care professional, sanitation, health care worker safety and welfare, odor control, cost, disposal, as well as ease of use in all steps in the process, such as one-handed use while the other hand is occupied with other things.

Thus, a system having the aforementioned advantages and solving the aforementioned problems is desired.

### SUMMARY OF THE PRESENT INVENTION

In one aspect of the present invention, a collection bag is provided for collection, measurement, and disposal of patient output. The collection bag includes a bag configured for positioning in a commode, the bag including upper and lower chambers separated by a transverse line defining apertures to allow gravitational separation of urine and fecal matter input into the upper chamber due to the urine flowing by gravity into the lower chamber. The upper chamber defines an input opening that is upwardly open and the lower chamber includes a drain opening. The bag lower chamber includes markings to facilitate measurement of collected urine. A clamp is positioned on the drain opening for permitting the urine to be drained prior to disposal. An upper closure member is provided for closing the upper chamber to facilitate containment of collected matter and safe disposal.

In another aspect of the present invention, a collection bag includes a bag configured for positioning in a commode, the bag including upper and lower chambers separated by a transverse line defining apertures for gravitational separation of urine and fecal matter input into the upper chamber due to the urine flowing by gravity into the lower chamber. The upper chamber defines an input opening that is upwardly open and the lower chamber includes a releasably-closed drain opening. The bag lower chamber includes markings to facilitate measurement of collected urine. A top of the bag includes a folded flange forming a rim. A drawstring is located under the folded flange for drawing the top of the bag to a first position sufficiently tight around a commode for collection of matter and also for drawing the top of the bag to a closed second position for sealing the collected matter therein. A slip lock member is provided on the drawstring for holding the drawstring in a selected one of the first and second positions.

In another aspect of the present invention, a collection bag includes a bag configured for positioning in a commode, the bag including upper and lower chambers separated by a transverse line defining apertures for gravitational separation of urine and fecal matter input into the upper chamber due to the urine flowing by gravity into the lower chamber. The upper chamber defines an input opening that is upwardly open and the lower chamber includes a drain opening. The bag lower chamber includes markings to facilitate measurement of collected urine. An upper member is provided on the bag for holding the bag in the commode for collection of matter. A clamp is located at the drain opening and configured with a release and an adjacent handle for one-handed release while maintaining control of a lower end of the bag.

In another aspect of the present invention, a method of collecting, measuring, and disposing of urine and fecal matter from a patient, comprises steps of placing a collection bag in a commode, the collection bag having upper and lower chambers connected by at least one flow-through opening. The method further includes collecting urine and fecal matter, with the urine passing through the opening to the lower chamber, pulling a drawstring to close the upper chamber, and documenting a volume of the urine and an amount of the fecal matter. The method still further includes opening a clamp with one hand to dump the urine while holding the bag with another hand, wrapping the bag with excess string on the drawstring, and securing the excess string to prevent unwrapping.

These and other aspects, objects, and features of the present invention will be understood and appreciated by those skilled in the art upon studying the following specification, claims, and appended drawings.

### BRIEF DESCRIPTION OF DRAWINGS

FIG. 1 is a side perspective view of a collection bag embodying the present inventive concepts.

FIGS. 2-3 are perspective views of the collection bag of FIG. 1 positioned in a commode and also lifted from the commode, respectively.

FIGS. 4-5 are side views of an upper portion of the collection bag of FIG. 3, FIG. 4 showing the drawstring drawn tight and FIG. 5 showing the slip lock drawn tight on the drawstring.

FIGS. 6-7 are side views of a lower portion of the collection bag, FIG. 6 showing the drain opening with the clamp released for draining urine and FIG. 7 showing the clamp being re-clamped, both with one-handed operation.

FIGS. 8-10 are orthogonal views of the clamp.

FIG. 11 is a flow diagram showing the method of use.

### DETAILED DESCRIPTION OF PREFERRED EMBODIMENTS

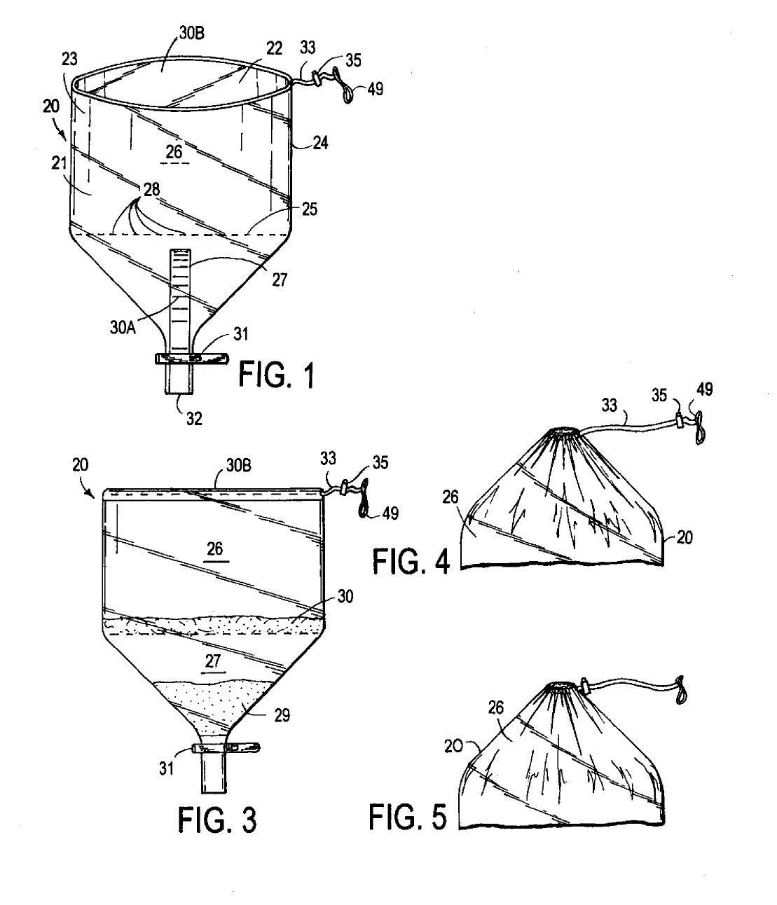

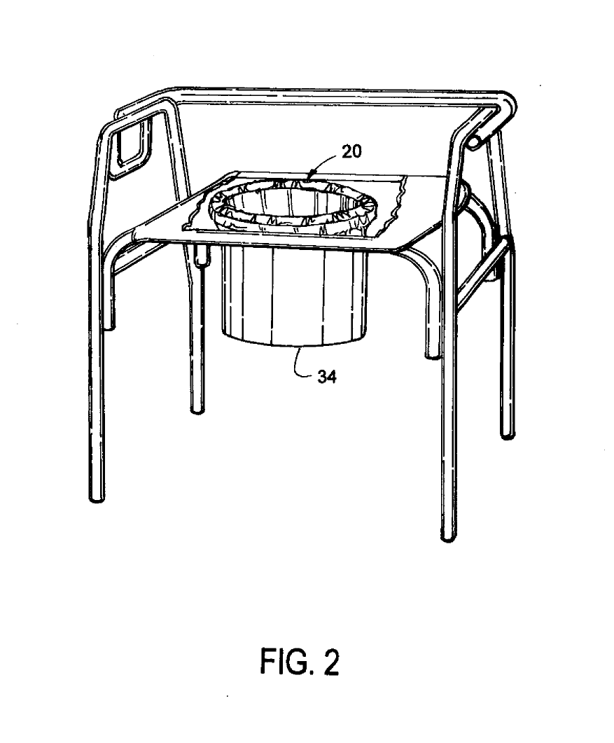

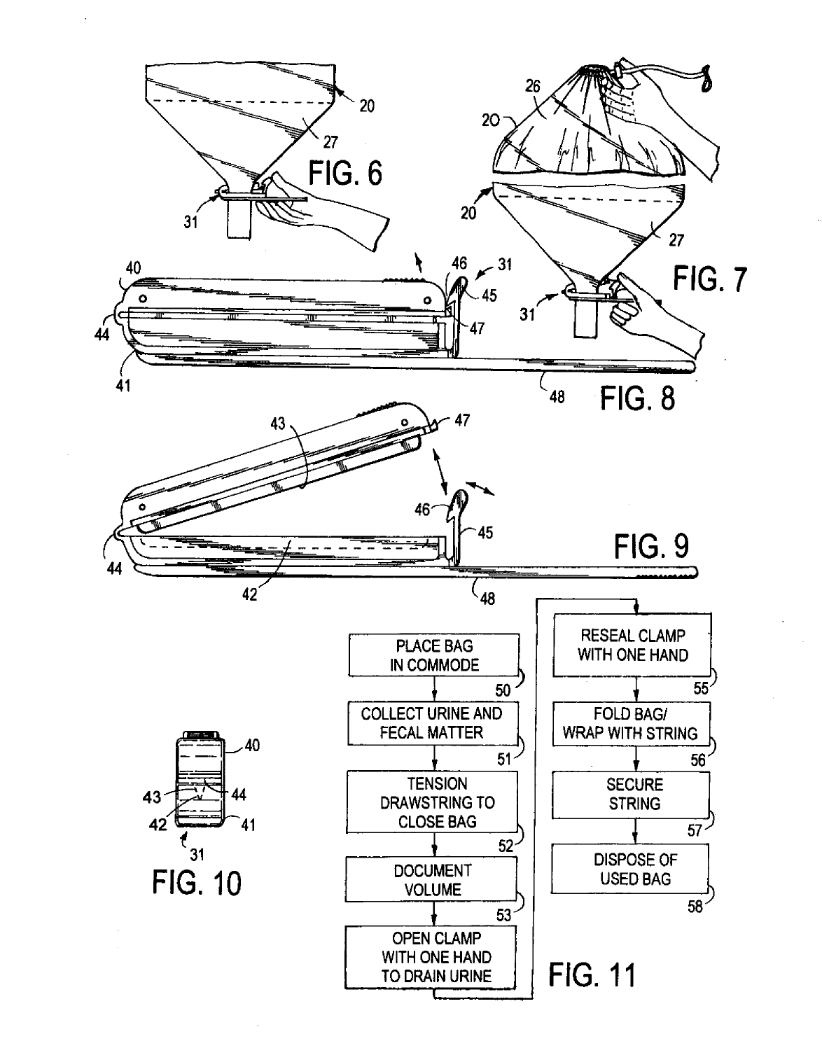

The present collection bag 20 (FIG. 1) is adapted for safe and sanitary collection of patient output, and for accurate separate measurement of urine and fecal output. Specifically, the bag 20 includes opposing panels 21 and 22 heat-sealed together along edges 23 and 24 and along a line of bonding 25 across its middle to form upper and lower chambers 26 and 27 separated by apertures 28 along the transverse line of bonding 25. This allows for gravitational separation of collected urinal and fecal matter 29 and 30. Markings 30A are provided on one side to facilitate measurement of the collected urine and fecal matter 29 and 30. One side panel (21) can be made opaque to visually cover the contents when the bag 20 is folded for disposal. A clamp 31 closes the drain opening 32 in lower chamber 27, but the urine can be released by opening the clamp 31 with one hand while holding a grip on the clamp 31. The clamp 31 can then be re-clamped (again by the use of only a single hand) for waste containment. Advantageously, the lower end of the bag 31 can be controlled by grasping the handle on the clamp 31 to manipulate the bag during folding. A top edge of the bag 20 is folded back and welded to form a tunnel, and a drawstring 33 extends under around the top of the upper chamber 26.

The drawstring 33 can be tensioned to facilitate positioning and attachment of the bag 20 in and to the commode 34. A slip lock 35 on the string 33 can be slid to hold the drawstring 33 in a tensioned condition to close an input opening 30B at a top of the bag 20. Further, once the bag 20 is removed from the commode 34, the drawstring 33 can be tensioned to close the bag 20 at its top. The slip lock 35 can be used to hold the bag 20 closed. After collection and measurement of urine and fecal matter, and after dumping of the urine, the bag 20 can be easily folded by using the handle on the clamp 31 as a gripping location to manipulate and fold up the bag 20. The folded bag 20 can be held in its folded condition by using the excess length of the drawstring 33 to wrap around and tie the bag closed (not specifically shown). If desired, a rubber band or tape (not shown) can be used to hold the drawstring 33 in a permanent folded condition.

In a preferred embodiment, the panels 21 and 22 are plastic non-tearable sheets, such as less than about 0.3 mm thick polyethylene or polyolefin sheet, one being transparent (21) and the other being opaque (22) (such as white or black). The markings 30A are on the transparent sheet 21 where they are easily seen. The opaque sheet 22 is located on an outside of bag 20 when the bag 20 is folded to hide the waste product. Preferably, the two sheets 21 and 22 are able to be reliably thermally welded to each other along their side edges and intermittently along the transverse line 25, such that the final two-compartment bag 20 can be quickly manufactured at a low cost. However, it is conceived that the bag 20 can be made in other ways, such as by folding a single sheet in half to form the two panels 21 and 22, or extruding a sleeve-like blown-film tube and then bonding and cutting the tube to form a structure similar to that shown in FIG. 1. Also, it is conceived that the bonding of one panel to the other can be achieved in different ways, such as by RF welding, sonic bonding, vibration welding, adhesive means, other thermal or chemical bonding means. It is conceived that the sheets can be biodegradable, but preliminary testing has shown that the industry does not demand this.

The drawstring 33 is extended through a tunnel formed by a reversely folded and bonded flap along the top edge of the bag 20. It is contemplated that the drawstring 33 can be a cord, or a strip of any material that is suitably strong for its intended purpose. Notably, many trash bags include a drawstring arrangement that could be incorporated into the present bag 20. A slip lock 35 is positioned on the drawstring 33. The illustrated slip lock 35 includes two members telescopingly inter-connected and positioned on the string 33, and further includes an internal spring for biasing the two members apart so that they lock onto the string 33. The slip lock 35 can be adjusted by squeezing the two members together against a bias of the internal spring, moving the slip lock 35 along the string 33, and then releasing the two members. Slip locks are commercially available and often used on backpacks and the like, such that a detailed discussion of them is not required for an understanding of the present invention.

A top of the bag 20 is sufficiently large to extend outward to generally match an interior of a standard commode. In the illustrated bag 20, the top is about 18 inches to 20 inches wide when folded flat, and continues this width downwardly to the weld line 25. In the lower chamber 27, the bag 20 tapers to a smaller size, such as about 1-½ inches wide at the outlet 32.

The clamp 31 includes top and bottom elongated clamping members 40 and 41, one including a channel 42 and the other including a blade 43 that fits into the channel 42 for a tight interfitting seal. The clamping members 40 and 41 are connected by a living hinge 44 at one end, and a release lever 45 extends from the clamping member 40. The release lever 45 includes a hook 46 that releasably engages a protruding catch 47 on the other clamping member 41 for secure closure. A base of the release lever 45 is resilient and provides a spring bias to move the hook 46 to a normally latched/closed position. A handle 48 extends from the clamping member 40 adjacent the release lever 45, so that a health care provider can manipulate the clamp 31, including the release lever 45, with a single hand (while holding the bag 20 with the other hand). Also, the health care provider can re-close the clamp 31 with a single hand (while holding the bag 20 with the other hand), such as by grasping the handle 48 with their 3-4-5′ fingers, and squeezing the clamping members 40-41 together using their thumb and first finger. Further, the health care provider can use the handle 48 to manipulate and fold the bag 20, while maintaining good control over the bag and its contents. The excess length of the drawstring 33 can be wrapped around the bag 20 as the bag 20 is folded. If desired, a securement member, such as a rubber band 49, can be attached to an end of the string 33 to elastically hold the bag 20 in its folded condition. It is contemplated that other means can be used to retain the folded bag 20 in its folded condition, such as an adhesive tape, slit, or protrusion on the bag 20. It is also contemplated that one of the clamping members 40 or 41 could be attached to the bag 20 so that it is not lost or dropped.

A method for using the present bag 20 follows for collecting, measuring, and disposing of urine and fecal matter from a patient. The method includes steps of placing a collection bag in a commode, the collection bag having upper and lower chambers connected by at least one flow-through opening (step 50). The method further includes collecting urine and fecal matter, with the urine passing through the opening to the lower chamber (step 51); pulling a drawstring to close the upper chamber (step 52); and documenting a volume of the urine and an amount of the fecal matter (step 53). The method still further includes opening a clamp with one hand to dump the urine while holding the bag with another hand (step 54); resealing the clamp with the one hand (step 55); wrapping the bag (potentially using the clamp as a grip) with excess string on the drawstring (step 56); securing the excess string to prevent unwrapping (step 57); and appropriately discarding the bag and contents (step 58).

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A collection bag adapted for collection, measurement, and disposal of patient output, comprising:
a bag configured for positioning in a commode, the bag including upper and lower chambers separated by a transverse line of bonded material, the line defining apertures to allow gravitational separation of urine and fecal matter input into the upper chamber due to the urine flowing by gravity into the lower chamber, the upper chamber defining an input opening that is upwardly open and the lower chamber including a drain opening, the bag lower chamber including markings to facilitate measurement of collected urine; and
a clamp on the drain opening for permitting the urine to be drained prior to disposal; and
an upper closure member for closing the upper chamber to facilitate containment and safe disposal.

2. The collection bag defined in claim 1, wherein the bag includes two panels with heat-sealed portions along the transverse line.

3. The collection bag defined in claim 2, wherein the clamp includes a release member and a handle adjacent the release member for one-handed release.

4. The collection bag defined in claim 3, wherein the clamp has opposing clamping members, one of which has a latch for engaging the release and a thumb-receiving surface arranged for one-handed re-clamping, so that a care-providing professional can hold the bag with one hand and unclamp and then later re-clamp the bag with their other hand.

5. The collection bag defined in claim 3, wherein the closure member includes a drawstring.

6. The collection bag defined in claim 5, wherein a top of the bag includes a folded flange forming a passageway and wherein the drawstring is slidably located in the passageway.

7. The collection bag defined in claim 5, including a slip lock on the drawstring to hold the string tight after the input opening is drawn closed by tensioning the drawstring.

8. The collection bag defined in claim 2, wherein one of the two panels is one of transparent and translucent.

9. The collection bag defined in claim 2, wherein one of the two panels is opaque.

10. The collection bag defined in claim 1, wherein the clamp is configured with a release lever and includes a handle adjacent the release lever for one-handed release.

11. The collection bag defined in claim 10, wherein the clamp has opposing clamping members, one of which has a catch for engaging the release and also has a surface to facilitate one-handed re-clamping, whereby the care-providing professional can hold the bag with one hand and unclamp and then later re-clamp the clamp with their other hand.

12. The collection bag defined in claim 10, wherein the clamp is attached to the bag at the drain opening and closes the drain opening.

13. The collection bag defined in claim 10, wherein the closure member includes a drawstring.

14. The collection bag defined in claim 13, including a slip lock on the drawstring to hold the string taut after the input opening is closed by drawstring.

15. The collection bag defined in claim 1, wherein a top of the bag includes a folded flange containing a drawstring therein.

16. The collection bag defined in claim 1, including a rubber band attached to the bag to secure the bag in a folded position for disposal.

17. The collection bag defined in claim 16, including a securement member attached to the string so that the string can be wrapped around the bag and then secured by the securement member to hold the bag a string-wrapped folded condition.

18. A collection bag adapted for collection, measurement, and disposal of patient output, comprising:
a bag configured for positioning in a commode, the bag including upper and lower chambers separated by a transverse line defining apertures for gravitational separation of urine and fecal matter input into the upper chamber due to the urine flowing by gravity into the lower chamber, the upper chamber defining an input opening that is upwardly open and the lower chamber including a releasably-closed drain opening, the bag lower chamber including markings to facilitate measurement of collected urine; a top of the bag including a folded flange forming a rim;
a drawstring under the folded flange for drawing the top of the bag to a first position tight around a commode for collection of matter and also for drawing the top of the bag to a closed second position for sealing the collected matter therein; and
a slip lock member on the drawstring for holding the drawstring in one of the first and second positions.

19. The collection bag defined in claim 18, wherein the bag comprises two panels with heat-bonded portions along the transverse line.

20. The collection bag defined in claim 18, including a clamp configured with a release lever and an adjacent handle for one-handed release.

21. The collection bag defined in claim 20, wherein the clamp has opposing clamping members, one of which has a catch for engaging the release and a surface configured for one-handed re-clamping, whereby the care-providing professional can hold the bag with one hand and unclamp and then later re-clamp the clamp with their other hand.

22. A collection bag adapted for collection, measurement, and disposal of patient output, comprising:
a bag configured for positioning in a commode, the bag including upper and lower chambers separated by a transverse line defining apertures for gravitational separation of urine and fecal matter input into the upper chamber due to the urine flowing by gravity into the lower chamber, the upper chamber defining an input opening that is upwardly open and the lower chamber including a drain opening, the bag lower chamber including markings to facilitate measurement of collected urine;
an upper member for holding the bag in the commode for collection of matter; and
a clamp located at the drain opening and configured with a release and with an adjacent handle for one-handed release.

23. The collection bag defined in claim 22, wherein the clamp has opposing clamping members, one of which has a catch for engaging the release and a thumb-receiving surface for one-handed re-clamping, whereby the care-providing professional can hold the bag with one hand and unclamp and then later re-clamp with their other hand.

24. The collection bag defined in claim 22, wherein the clamp is attached to the bag at the drain opening.

25. A method of collecting, measuring, and disposing of urine and fecal matter from a patient, comprising steps of:
placing a collection bag in a commode, the collection bag having upper and lower chambers connected by at least one flow-through opening;
collecting urine and fecal matter, with the urine passing through the opening to the lower chamber;
pulling a drawstring to close the upper chamber;
documenting a volume of the urine and an amount of the fecal matter;
opening a clamp with one hand to dump the urine while holding the bag with the other hand;
wrapping the bag with excess string on the drawstring; and
securing the excess string to prevent unwrapping.

26. The method defined in claim 25, including resealing the clamp with the one hand.

27. The method defined in claim 25, including using the clamp as a grip to fold the bag.
